(19) United States
(12) Patent Application Publication
(10) Pub. No.: US 2017/0342844 A1
(43) Pub. Date: Nov. 30, 2017

(54) High Temperature Composites With Enhanced Matrix

(71) Applicant: UNITED TECHNOLOGIES CORPORATION, Farmington, CT (US)

(72) Inventors: Wayde R. Schmidt, Pomfret Center, CT (US); Paul Sheedy, Bolton, CT (US); Neal Magdefrau, Tolland, CT (US)

(21) Appl. No.: 15/168,522

(22) Filed: May 31, 2016

(51) Int. Cl. F01D 5/28; C04B 35/80; F01D 5/14; F01D 11/08; F04D 29/54; C03C 14/00; F01D 25/00; F04D 29/32; F01D 9/04

(52) U.S. Cl. CPC F01D 5/288; F04D 29/324; C04B 35/80; F01D 5/147; F01D 9/041; F04D 29/542; C03C 14/002; F01D 25/007; F01D 11/08; F05D 2220/32; F05D 2230/90; F05D 2240/35; F05D 2300/611

(57) ABSTRACT

A composite article comprises a substrate, the substrate comprising a silicon containing material and an additive comprising boron nitride nanotubes.

### BACKGROUND

The present disclosure is directed to composite articles such as those used in gas turbine engines.

Components, such as gas turbine engine components, may be subjected to high temperatures, corrosive and oxidative conditions, and elevated stress levels.

There is an ongoing need to provide increased temperature capability, environmental stability and strength retention to advanced coatings, monolithic ceramics, ceramic matrix composites and other high temperature material systems for aerospace propulsion equipment. Existing glass and ceramic matrix composites generally suffer from poor thermal conductivity of the matrix.

### SUMMARY

In accordance with the present disclosure, there is provided a composite article comprising a substrate, the substrate comprising a silicon containing material and an additive comprising boron nitride nanotubes.

In another and alternative embodiment, the silicon containing material is selected from the group consisting of glass, glass/ceramic, monolithic ceramic, and ceramic matrix composite.

In another and alternative embodiment, the boron nitride nanotubes are one of chemically modified and physically modified with additional layers, wherein the additional layers comprise coatings of oxide materials selected from the group consisting of Al, Si, Ba, Ti, Y, La, Ga, Ta, Zr, Hf, Sr, Ca and the like and combinations thereof.

In another and alternative embodiment, the additional layers may be comprised of other compositions such as nitrides, borides, carbides, oxycarbides, oxynitrides, carbonitrides, carbon, metals, or combinations thereof.

In another and alternative embodiment, the modification comprises atomic layer deposition.

In another and alternative embodiment, the composite article further comprises at least one of an environmental barrier coating, a thermal barrier coating, a velocity barrier, an abradable coating, and erosion resistant coating coupled to the substrate.

In another and alternative embodiment, the substrate comprises at least one of a material formed of a single, continuous mass of material and a composite of several different ceramic materials, carbon-based material or ceramic and metallic and carbon-based material.

In another and alternative embodiment, the additive is uniformly dispersed in at least one of the substrate and at least one of an environmental barrier coating, a thermal barrier coating, a velocity barrier, an abradable coating, and an erosion resistant coating coupled to the substrate.

In accordance with the present disclosure, there is provided a turbine engine component comprising a substrate, the substrate comprising a silicon containing material, wherein the silicon containing material is selected from the group consisting of glass, glass/ceramic monolithic ceramic, and ceramic matrix composite; and an additive comprising boron nitride nanotubes.

In another and alternative embodiment, the turbine engine component further comprises at least one of an environmental barrier coating, a thermal barrier coating, a velocity barrier, an abradable coating, and an erosion resistant coating coupled to the substrate.

In another and alternative embodiment, the boron nitride nanotubes are one of chemically modified and physically modified with additional layers, wherein the additional layers comprise coatings of selected from the group consisting of Al, Si, Ba, Ti, Y, La, Ga, Ta, Zr, Hf, Sr, Ca and the like and combinations thereof.

In another and alternative embodiment, the additive is uniformly dispersed in at least one of the substrate and at least one of an environmental barrier coating, a thermal barrier coating, a velocity barrier, an abradable coating, and an erosion resistant coating coupled to the substrate.

In another and alternative embodiment, the substrate comprises at least one of a material formed of a single, continuous mass of material and a composite of several different ceramic materials, carbon-based material or ceramic and metallic and carbon-based material.

In another and alternative embodiment, the turbine engine component is selected from the group consisting of a combustor liner, an airfoil, a turbine blade or vane, a compressor blade or vane, blade outer air seal.

In accordance with the present disclosure, there is provided a process for enhancing the thermal and mechanical properties of a composite material, the process comprises the steps of providing a composite material; and adding a boron nitride nanotube additive to the composite material.

In another and alternative embodiment, the composite material is formed from a silicon-containing material.

In another and alternative embodiment, the silicon-containing material is selected from the group consisting of glass, glass/ceramic, monolithic ceramic, and ceramic matrix composite.

In another and alternative embodiment, the process further comprises modifying the boron nitride nanotubes by adding additional layers to the boron nitride nanotubes.

In another and alternative embodiment, the additional layers comprise coatings of oxide materials selected from the group consisting of Al, Si, Ba, Ti, Y, La, Ga, Ta, Zr, Hf, Sr, Ca and the like and combinations thereof.

In another and alternative embodiment, the process further comprises coating the composite material with at least one of an environmental barrier coating, a thermal barrier coating, a velocity barrier, an abradable coating, and an erosion resistant coating.

In another and alternative embodiment, the process further comprises uniformly dispersing the additive throughout at least one of the composite material and at least one of the environmental barrier coating, the thermal barrier coating, the velocity barrier, the abradable coating, and the erosion resistant coating.

Other details of the coated boron nitride nanotube enhanced composites are set forth in the following detailed description and the accompanying drawing wherein like reference numerals depict like elements.

### BRIEF DESCRIPTION OF THE DRAWINGS

FIG. 1 schematically illustrates an example composite article that is a turbine blade.

FIG. 2 schematically illustrates a cross-section of a portion of a composite article having an enhanced matrix that includes boron nitride nanotubes.

FIG. 3 schematically illustrates a cross-section of a portion of a layered structure having an intermediate layer with discrete regions of boron nitride nanotubes.

FIG. 4 is a process diagram of an exemplary method.

### DETAILED DESCRIPTION

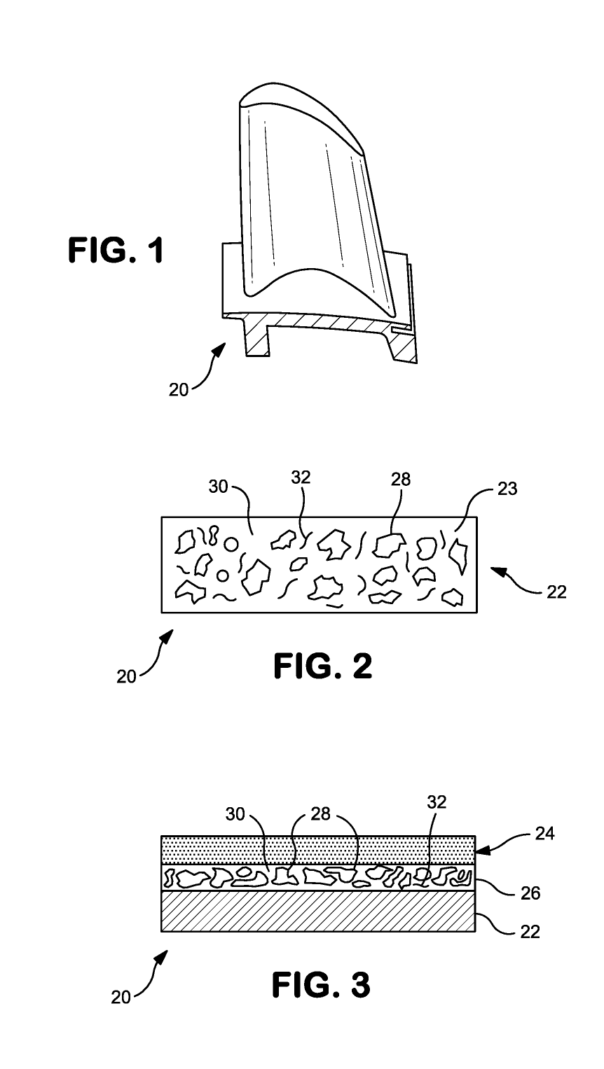

FIG. 1 shows a composite article 20. In this example, the composite article 20 is a turbine blade for a gas turbine engine, although this disclosure is not limited to such components. The composite article 20 may alternatively be a combustor liner, a turbine vane, compressor blade or vane, an airfoil, a blade outer air seal or other component that would benefit from this disclosure. It is also to be understood that the composite article 20 is not limited to components that are used for gas turbine engines and that components in other fields that are subjected to harsh thermal and environmental conditions will also benefit from this disclosure.

FIGS. 2 and 3 show a cross-section of a portion of the composite article 20. As an example, the portion may be from the airfoil-shaped blade section of the turbine blade. The composite article 20 includes a substrate 22, at least one protective layer 24 on the substrate, and an intermediate layer 26 between the protective layer 24 and the substrate 22. The protective layer 24, or layers, and the intermediate layer 26, or layers, may together be considered to be an environmental barrier coating, thermal barrier coating, velocity barrier, abradable coating, or erosion resistant coating, depending upon the materials selected for the respective layers 24 and 26.

The substrate 22 in the illustrated example comprises a ceramic material, a glass or glass/ceramic, carbon or combinations thereof. The ceramic material may include carbides, oxides, nitrides, borides, silicides, oxycarbides, oxynitrides, carbonitrides, aluminides, silicates, titanates, phosphates, phosphides, or combinations thereof. The glass and glass/ceramic materials may include silica, borosilicates, barium aluminosilicates, lanthanum aluminosilicates, strontium magnesium silicates, barium magnesium aluminosilicates, calcium magnesium aluminosilicates and lithium-containing glasses, silicates or aluminosilicates.

The substrate 22 in the illustrated example may be monolithic (i.e., formed of a single, continuous mass of material) or a composite of several different ceramic materials, carbon-based material or ceramic and metallic and carbon-based materials. In one example, the substrate 22 is a ceramic matrix composite 23, where the ceramic matrix material forms a continuous phase 30, in which at least one reinforcement phase of another material 28, 32, is distributed. The reinforcement phase can be a discontinuous phase of another material, such as a filler or particulate, or the reinforcement phase can be a continuous phase, such as fibers. Combinations of reinforcement phases are also contemplated. The reinforcing phase may also consist of chopped fibers. The ceramic matrix 30 may be selected from carbides, oxides, nitrides, borides, silicides, oxycarbides, oxynitrides, carbonitrides, aluminides, silicates, titanates, phosphates, phosphides, borosilicate and aluminosilicate glasses or combinations thereof.

In a further example, the ceramic material includes a silicon-containing ceramic material, such as silicon carbide, silicon oxycarbide, silicon nitride, silicon oxynitride, or a glass, glass/ceramic material, or other oxide, carbide, nitride, boride, or combination thereof that includes silicon. Additional examples of desirable ceramic materials include boron-containing ceramic materials, titanium-containing ceramic materials, aluminum-containing ceramic materials, molybdenum-containing ceramic materials and barium-containing ceramic materials.

The ceramic matrix composite 23 can contain a filler/fiber or particulate additive 32 comprising boron nitride nanotubes (BNNT). The incorporation of the boron nitride nanotubes enhances the thermal and mechanical performance of the glass, glass/ceramic, and ceramic matrix composite 23 system. Boron nitride nanotubes are materials that exhibit high chemical stability, thermal stability (up to 800 C in air), excellent thermal conductivity, a very high Youngs modulus (up to 1.3 TPa), piezoelectricity, the ability to suppress thermal neutron radiation, and, as a matted fabric, display super-hydrophobicity.

The additive 32 can include coated BNNT. The BNNT can be chemically or physically modified with an additional layer or layers, by Atomic Layer Deposition, for example, to provide desirable compositions that further enable the glass, glass/ceramic or ceramic system. Additional, non-limiting coating methods are also contemplated including chemical and physical vapor deposition, plasma deposition, solution and slurry-based processing. In one example, Atomic Layer Deposition coatings of various oxides, selected from the group consisting of Al, Si, Ba, Ti, Y, La, Ga, Ta, Zr, Hf, Sr, Ca and the like and combinations thereof can be selected and deposited to enhance the interaction between the reinforcement nanotubes and the glass, glass/ceramic or ceramic matrix or coating.

FIG. 3 shows a cross-section of a portion of a composite article 20 that is similar to the composite article 20 shown in FIG. 2 with regard to the substrate 22 and protective layer 24. An intermediate layer 26, between the substrate 22 and protective layer 24, includes silicon oxycarbide, as described above. In this example, the silicon oxycarbide occupies a plurality of discrete regions 28 within the intermediate layer 26. The regions 28 are perceptibly distinct (e.g., by metallographic techniques) and may be approximately 1-250 micrometers in average diameter. In one example, the silicon oxycarbide of the regions 28 is nominally, substantially or fully dense silicon oxycarbide, as described above. The regions 28 of silicon oxycarbide and boron nitride nanotube additive 32 are dispersed within a matrix region 30. In the illustrated example, the matrix region 30 is continuous and generally surrounds the regions 28, although in other examples the silicon oxycarbide is the continuous matrix in which another material is dispersed. The intermediate layer 26 may be of a desired thickness for protecting the underlying substrate 22. For example, the intermediate layer 26 may be 10-1000 micrometers thick and in some examples is 25-500 micrometers thick.

The material of the matrix region 30 is or includes carbides, oxides, nitrides, borides, silicides, oxycarbides, oxynitrides, carbonitrides, aluminides, silicates, titanates, phosphates, phosphides, or combinations thereof. In further examples, the matrix region 30 includes hafnium, yttrium, molybdenum, silicon dioxide, silicon carbide or combinations thereof. In one example, the material of the matrix region 30 includes hafnia (HfO₂). In other examples, the silicate material of the matrix region 30 may include a rare earth element silicate material that includes a rare earth element selected from the 15 lanthanide series elements, yttrium and scandium. In one example, the material of the matrix region 30 contains yttrium silicate. The ratio of the rare earth element to silica may vary between 1:0.8 and 1:4 by mole content. In another example, the material of the matrix region 30 includes molybdenum disilicide (MoSi₂). Alternatively, or in combination with the above example materials, the material of the matrix region 30 includes at least one of silicon dioxide (SiO₂) or silicon carbide (SiC).

In a further example, the material of the matrix region 30 is a silicate material. For instance, the silicate material is a refractory metal silicate, a rare earth metal silicate or combination thereof. In one example, the silicate is a silicate of a rare earth metal, hafnium and zirconium. Refractory metals include niobium, molybdenum, tantalum, tungsten, rhenium, titanium, vanadium, chromium, zirconium, hafnium, ruthenium, osmium, iridium and combinations thereof. Rare earth metals include the fifteen lanthanide elements, scandium, yttrium and combinations thereof.

In a further example, the material of the matrix region 30 is an oxide material. For instance, the oxide material is a refractory metal oxide, such as hafnia, yttria, rare earth oxide, or combination thereof.

The amount of boron nitride nanotube additive 32 in the intermediate layer 26 may be varied depending upon the properties desired for the end use application. The BNNT provides the composite article 20 with thermal/oxidative stability and thermal expansion matching between the substrate and the protective layer 24. The thermal and oxidative stability of the silicon oxycarbide may be enhanced through the addition of the materials 32 of the matrix region 30. In that regard, the amount of silicon oxycarbide may be varied relative to the amount of additive material 32 in the matrix region 30 and the total amount of additive material 32 in the intermediate layer 26.

The additive 32 can be incorporated into the matrix 30 at any of various stages of ceramic composite manufacture. The additive 32 of BNNT can be incorporated into the glass slurry that coats fiber preforms. The additive 32 can be incorporated at a distinct step. Heat treatment of the composite 22 can be altered or adjusted. Any of the manufacturing processes can be employed to create the composite 22, such as by use of fiber preforms with resin or glass transfer molding for more complex geometries and compression molding for simpler geometries.

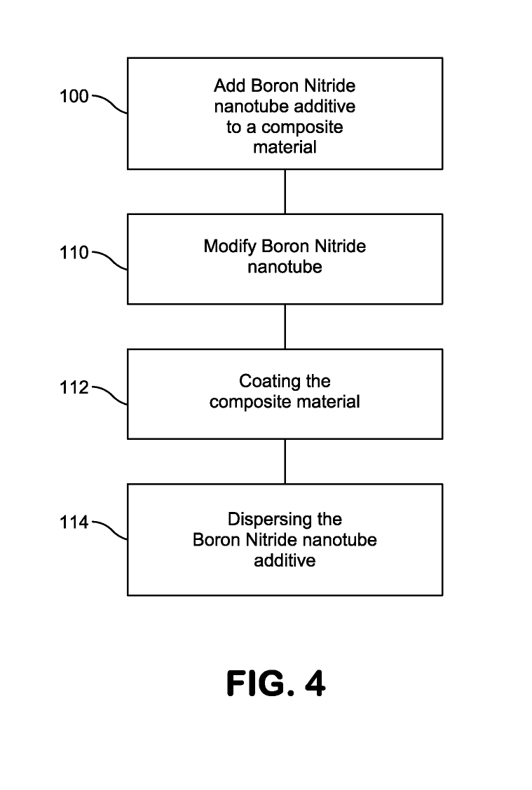

FIG. 4 illustrates an exemplary process for enhancing the thermal and mechanical properties of a composite material. At step 100 the thermal and mechanical properties of the composite material can be enhanced by adding a boron nitride nanotube additive to the composite material formed from a silicon-containing material. At step 110 the process includes modifying the boron nitride nanotubes by adding at least one additional layer to the boron nitride nanotubes. The process further includes the additional layers can comprise coatings of oxide materials selected from the group consisting of Al, Si, Ba, Ti, Y, La, Ga, Ta, Zr, Hf, Sr, Ca and the like and combinations thereof. In the process at step 112, the process further comprises coating the composite material with at least one of an environmental barrier coating, a thermal barrier coating, a velocity barrier, an abradable coating, and an erosion resistant coating. At 114, the process further comprises uniformly dispersing the additive throughout at least one of the composite material and at least one of the environmental barrier coating, the thermal barrier coating, the velocity barrier, the abradable coating, and the erosion resistant coating.

BNNT, coated or uncoated, provides the following potential benefits to glass, glass/ceramic and ceramic matrix composites, monoliths and composite matrices: enhanced mechanical strength by bridging micro cracks, enhanced thermal conductivity, enhanced composition control by selection of coating chemistry to drive certain grain growth or crystalline phase development and improved mechanical performance by pull-out along BNNT/glass interface, especially when BNNT coating is properly designed.

Specific to glass or glass/ceramic matrix composites or coatings having low thermal conductivity but otherwise excellent composite attributes, BNNT additive/filler/reinforcements are expected to significantly increase the thermal conductivity of matrices such as those containing lithium-aluminosilicate (LAS), barium magnesium-aluminosilicate (BMAS), calcium-magnesium-aluminosilicate (CMAS) or other highly refractory aluminosilicates. Additional examples of desirable ceramic materials include boron-containing ceramic materials, titanium-containing ceramic materials, aluminum-containing ceramic materials, molybdenum-containing ceramic materials and barium-containing ceramic materials.

There has been provided an enhanced composite article by use of BNNT additive. While the enhanced composite has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

What is claimed is:

1. A composite article comprising:
a substrate, said substrate comprising a silicon containing material and
an additive comprising boron nitride nanotubes.

2. The composite article according to claim 1, wherein said silicon containing material is selected from the group consisting of glass, glass/ceramic and ceramic matrix composite.

3. The composite article according to claim 2, wherein said boron nitride nanotubes are one of chemically modified and physically modified with additional layers, wherein said additional layers comprise coatings selected from the group consisting of Al, Si, Ba, Ti, Y, La, Ga, Ta, Zr, Hf, Sr, Ca and the like and combinations thereof.

4. The composite article according to claim 3, wherein said modification comprises atomic layer deposition.

5. The composite article according to claim 1, further comprising:
at least one of an environmental barrier coating, a thermal barrier coating, a velocity barrier, an abradable coating, and erosion resistant coating coupled to said substrate.

6. The composite article according to claim 1, wherein said substrate comprises at least one of a material formed of a single, continuous mass of material and a composite of several different ceramic materials, carbon-based material or ceramic and metallic and carbon-based material.

7. The composite article according to claim 1, wherein said additive is uniformly dispersed in at least one of the substrate and at least one of an environmental barrier coating, a thermal barrier coating, a velocity barrier, an abradable coating, and an erosion resistant coating coupled to said substrate.

8. A turbine engine component comprising:
a substrate, said substrate comprising a silicon containing material, wherein said silicon containing material is selected from the group consisting of glass, glass/ceramic and ceramic matrix composite; and
an additive comprising boron nitride nanotubes.

9. The turbine engine component according to claim 8.
further comprising:
at least one of an environmental barrier coating, a thermal barrier coating, a velocity barrier, an abradable coating, and an erosion resistant coating coupled to said substrate.

10. The turbine engine component according to claim 8, wherein said boron nitride nanotubes are one of chemically modified and physically modified with additional layers, wherein said additional layers comprise coatings selected from the group consisting of Al, Si, Ba, Ti, Y, La, Ga, Ta, Zr, Hf, Sr, Ca and the like and combinations thereof.

11. The turbine engine component according to claim 9, wherein said additive is uniformly dispersed in at least one of the substrate and at least one of an environmental barrier coating, a thermal barrier coating, a velocity barrier, an abradable coating, and an erosion resistant coating coupled to said substrate.

12. The turbine engine system according to claim 8,
wherein said substrate comprises at least one of a material formed of a single, continuous mass of material and a composite of several different ceramic materials, carbon-based material or ceramic and metallic and carbon-based material.

13. The turbine engine system according to claim 8, wherein turbine engine component is selected from the group consisting of a combustor liner, an airfoil, a turbine blade or vane, a compressor blade or vane, blade outer air seal.

14. A process for enhancing the thermal and mechanical properties of a composite material, said process comprising:
adding a boron nitride nanotube additive to said composite material formed from a silicon-containing material.

15. The process of claim 14, wherein said silicon containing material is selected from the group consisting of glass, glass/ceramic and ceramic matrix composite.

16. The process of claim 14, further comprising:
modifying said boron nitride nanotubes by adding at least one additional layer to said boron nitride nanotubes.

17. The process of claim 16, wherein said at least one additional layer comprises coatings of selected from the group consisting of Al, Si, Ba, Ti, Y, La, Ga, Ta, Zr, Hf, Sr, Ca and the like and combinations thereof

18. The process of claim 14, further comprising:
coating said composite material with at least one of an environmental barrier coating, a thermal barrier coating, a velocity barrier, an abradable coating, and an erosion resistant coating.

19. The process of claim 18, further comprising:
uniformly dispersing the additive throughout at least one of the composite material and at least one of the environmental barrier coating, the thermal barrier coating, the velocity barrier, the abradable coating, and the erosion resistant coating.
